(19) United States
(12) Patent Application Publication
(10) Pub. No.: US 2026/0116429 A1
(43) Pub. Date: Apr. 30, 2026

(54) Correlation of Magnetometric and Barometric Measurements for Automotive Applications

(71) Applicant: Torc Robotics, Inc., Blacksburg, VA (US)

(72) Inventors: Akshay PAI RAIKAR, Austin, TX (US); William Gray DAVIS, Austin, TX (US); Garrett MADSEN, Austin, TX (US); Joseph R. FOX-RABINOVITZ, Austin, TX (US)

(21) Appl. No.: 18/927,522

(22) Filed: Oct. 25, 2024

(51) Int. Cl. B60W 60/00; B60W 10/30; B60W 50/00; G01W 1/02

(52) U.S. Cl. CPC B60W 60/0015; B60W 10/30; B60W 50/0098; G01W 1/02; B60W 2050/0052; B60W 2555/20; B60W 2710/30; B60W 2720/10

(57) ABSTRACT

In one aspect, a computer-implemented method, includes a risk mitigation system receiving from a first sensor mounted on an autonomous vehicle, first sensor data. The first sensor data may be associated with a local magnetic field and is received periodically. The method may further include processing the first sensor data to identify an occurrence of an anomaly in the first sensor data. The occurrence may be associated with a time period. The risk mitigation system may request data from a second sensor mounted on the vehicle after identifying the anomaly. The method may further include receiving, from the second sensor, second sensor data. The second sensor data may be associated with an external environment of the autonomous vehicle. The risk mitigation system may process the second sensor data associated with the time period, and identify, based on the analyzed second sensor data and the anomaly, that the external environment is high-risk.

### TECHNICAL FIELD

The field of the disclosure relates generally to autonomous vehicles and, more specifically, to risk mitigation systems for autonomous vehicles.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Lightning strikes present a significant hazard to semi-trucks and other large vehicles, including the autonomous vehicles described herein, due to their substantial metal structures and elevated positions. When a vehicle is struck by lightning, the electrical current typically travels through the metal frame, potentially causing severe damage to electronic systems and compromising the integrity of the vehicle. Due to the complexity of the advanced electronic control systems in autonomous vehicles, including navigation, communication, and engine management systems, lightning-induced failures may be increasingly detrimental. Moreover, the unpredictability of lightning strikes, coupled with the need for continuous operation of semi-trucks in all weather conditions, underscores the necessity for effective protective measures. There remains a need for more reliable solutions and automated solutions for reducing the risk of lightning strikes in autonomous semi-trucks and other vehicles.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed computer-implemented method includes a risk mitigation system receiving from a first sensor mounted on an autonomous vehicle, first sensor data. The first sensor data may be associated with a local magnetic field and is received periodically. The method may further include processing the first sensor data to identify an occurrence of an anomaly in the first sensor data. The occurrence may be associated with a time period. The risk mitigation system may request data from a second sensor mounted on the autonomous vehicle after identifying the anomaly. The method may further include receiving, from the second sensor, second sensor data. The second sensor data may be associated with an external environment of the autonomous vehicle. The risk mitigation system may process the second sensor data associated with the time period, and identify, based on the analyzed second sensor data and the anomaly, that the external environment is high-risk.

In another aspect, the disclosed method may also include receiving orientation data from the first sensor, where the orientation data is received at the beginning of a trip associated with the autonomous vehicle. The method may further include generating, based on the orientation data, a filter, and monitoring the filter to determine if convergence has occurred. The method may further include initiating a monitoring session upon a determination that convergence has occurred. After identifying the external environment as high-risk, the method may further include transmitting a command to deploy a mitigation tactic. Deploying the mitigation tactic may also include transmitting instructions to a vehicle computing system to reduce a speed associated with the autonomous vehicle. Further, deploying the mitigation tactic may also include transmitting instructions to a vehicle computing system to deploy at least one of a lightning rod or a conductive chain. The method may also include where the first sensor is a magnetometer. The method may also include where the second sensor is a barometer. The method may also include where the anomaly is detected based on a temporal profile. Other technical features may be readily apparent to one skilled in the art from the following figures, descriptions, and claims.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRA WINGS

The following drawings form part of the present specification and are included to further demonstrate certain aspects of the present disclosure. The disclosure may be better understood by reference to one or more of these drawings in combination with the detailed description of specific embodiments presented herein.

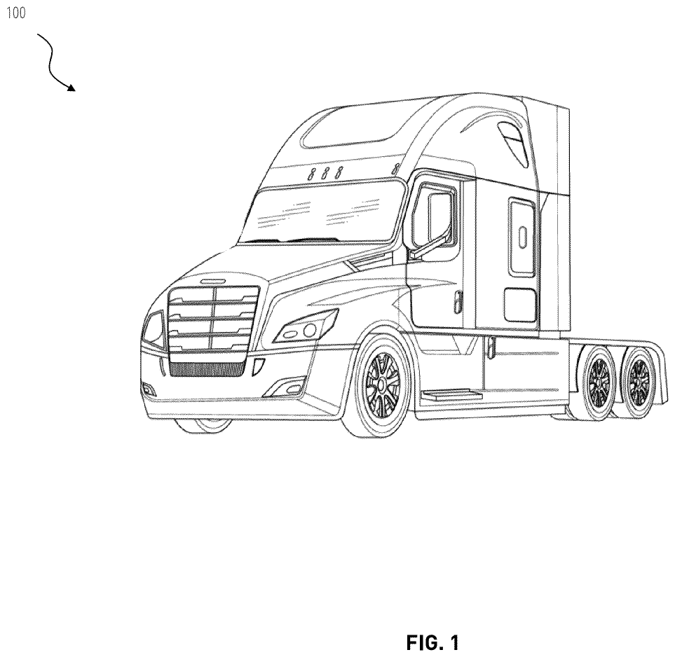

FIG. 1. is an example schematic view of an autonomous truck according to some aspects of the present disclosure.

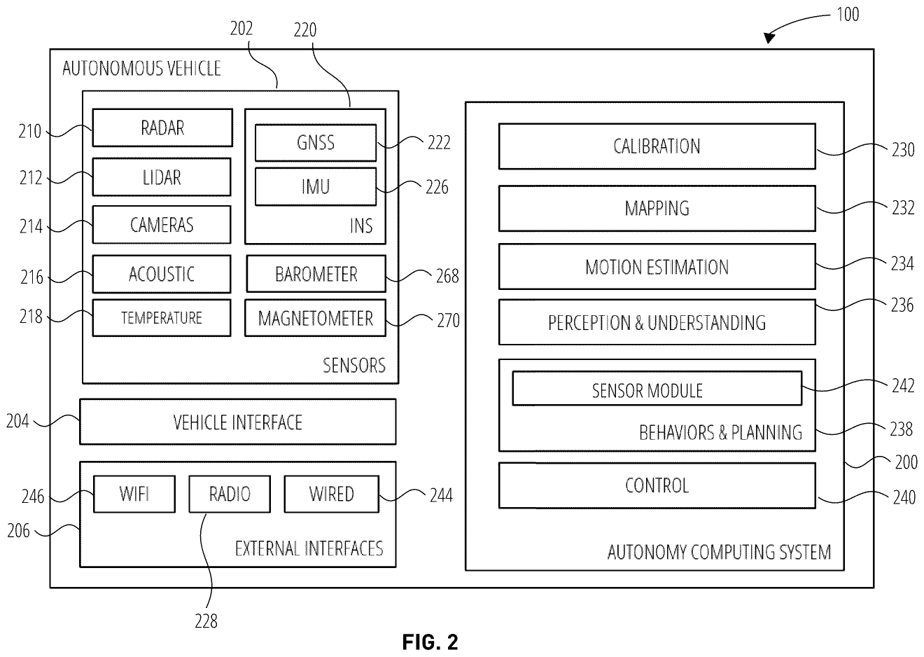

FIG. 2 is an example block diagram of the autonomous truck shown in FIG. 1 according to some aspects of the present disclosure.

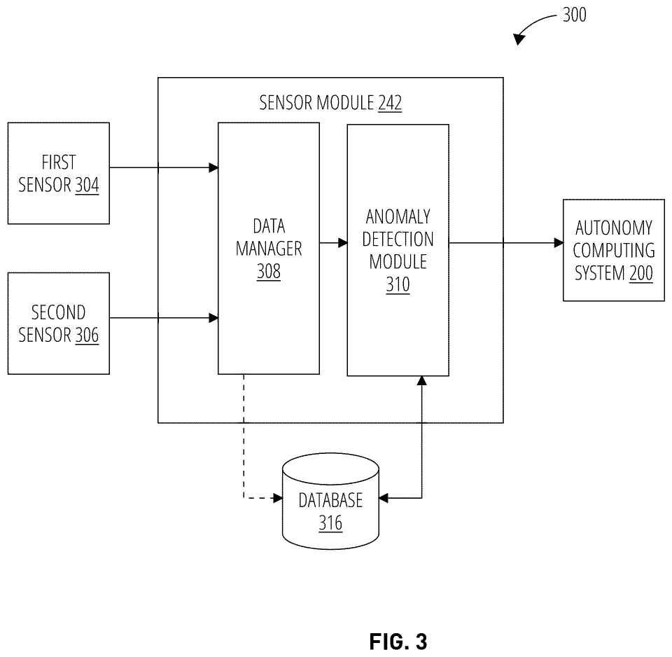

FIG. 3 illustrates an example block diagram of a sensor module configured to manage a risk mitigation system according to some aspects of the present disclosure.

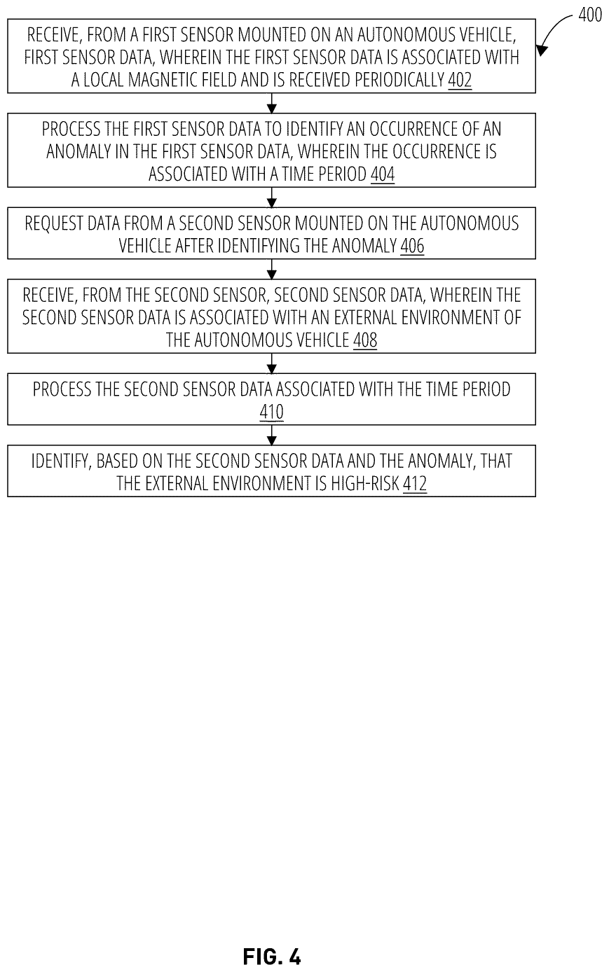

FIG. 4 illustrates an example flowchart for the risk mitigation system according to some aspects of the present disclosure.

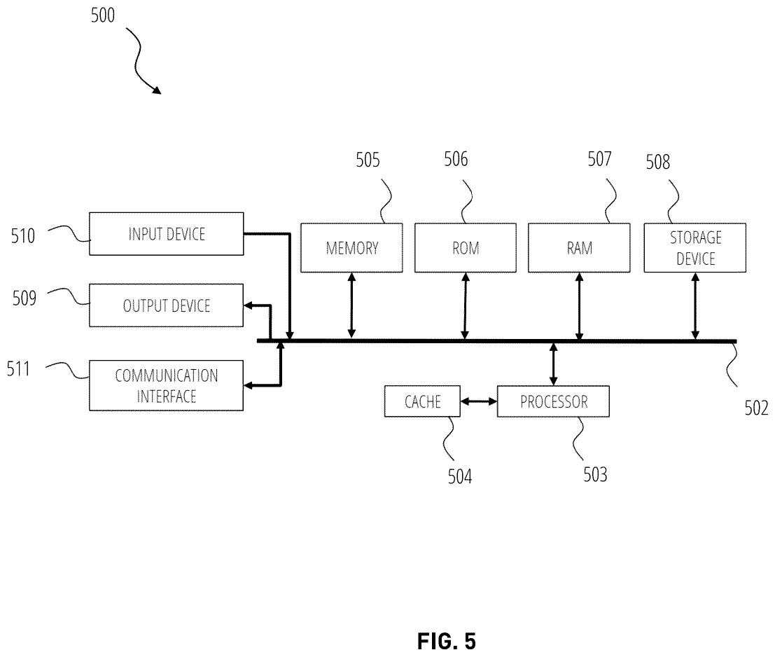

FIG. 5 is an example block diagram of a computing system according to some aspects of the present disclosure.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments, and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Lightning strikes on autonomous vehicles pose unique and significant challenges due to the extensive reliance on electronic and computer systems that control the vehicle's operation. Unlike conventional vehicles, autonomous vehicles depend on a network of sensors, cameras, radar, LiDAR, and advanced computing systems to navigate and make real-time decisions without human intervention. A lightning strike can disrupt or damage these critical components, leading to a loss of vehicle control, failure of navigation systems, or erroneous data processing. Such events not only endanger the safety of the vehicle and its occupants but can also cause broader public safety concerns, particularly if the autonomous vehicle is operating in traffic or urban environments. Additionally, the potential for permanent damage to high-cost electronic systems increases the economic impact of lightning strikes on autonomous vehicles. Therefore, ensuring robust protection against lightning strikes is essential to maintain the safety, reliability, and functionality of autonomous vehicles in all operating conditions.

Two methods of mitigating the impact of a lightning strike include lighting rods and conductive chains. The lightning rod may be deployed outside of the vehicle to direct a lightning strike through the frame of the vehicle, thereby avoiding computing equipment to mitigate potential damage to the autonomous vehicle. A conductive chain may be deployed at the base of the autonomous vehicle, in contact with the ground, as an additional measure to direct the lighting strike through the vehicle, avoiding electronics. In some examples, the lighting rod and the conductive chain may be used independently. However, in some other examples, both may be deployed to maximize the efficacy against lighting strikes. Due to the nature of lightning rods and conductive chains, it is unlikely that these components could be utilized while an autonomous vehicle is moving. Thus, the vehicle must be parked/still in order to reap the benefits of the lightning rods and/or conductive chains. Because of this, deploying lightning rods and/or conductive chains can be costly to the productivity of an autonomous vehicle, and could delay deliveries, reduce efficiency, create a backlog of tasks, any combination thereof, or the like. Thus, there exists a need in the art for a system for automatically deploying lightning mitigation tactics to both achieve maximum efficiency and ensure the safety of the autonomous vehicle.

The disclosed system may include one or more sensors configured to receive data associated with an external environment of an autonomous vehicle. The data may demonstrate a likelihood of a lightning strike occurrence in the immediate environment of the autonomous vehicle. In some examples, a magnetometer associated with the magnetic field may detect changes in the magnetic field that may indicate a high risk of a lightning strike. In some examples, this indication may be supported by data from a second sensor, which, in some instances, may be a barometer configured to detect changes in air pressure in the immediate environment of the autonomous vehicle. Using the data from the one or more sensors, which may include a magnetometer and/or a barometer, the disclosed system may detect when the autonomous vehicle is at a high risk of lightning strike.

When this high risk is detected, the autonomous vehicle may be equipped with one or more mitigation tactics that may be deployed when the one or more sensors detect the high risk of a lightning strike. The mitigation tactics may be physical modifications to the autonomous vehicle (e.g., lightning rods, conductive chains) or may be changes to programming associated with the autonomous vehicle (e.g., re-routing the vehicle, reducing speed, directing the autonomous vehicle to pull over, etc.).

FIG. 1. is an example schematic view of an autonomous truck according to some aspects of the present disclosure. FIG. 1 illustrates a vehicle 100, such as a truck that may be conventionally connected to a single or tandem trailer to transport the trailer (not shown) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors.

FIG. 2 is an example block diagram of the autonomous truck shown in FIG. 1 according to some aspects of the present disclosure. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, magnetometer 270, barometer 268, or inertial navigation system (INS) 220, which may include one or more global navigation satellite system (GNSS) receivers 222 and one or more inertial measurement units (IMU) 226. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or a hub or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 226 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 226 may measure an acceleration, angular rate, or an orientation of autonomous vehicle 100 or one or more of its individual components using a combination of accelerometers, gyroscopes, or magnetometers. IMU 226 may detect linear acceleration using one or more accelerometers and rotational rate using one or more gyroscopes and attitude information from one or more magnetometers. In some embodiments, IMU 226 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 246 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a sensor module 242. The sensor module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The sensor module 242 may perform one or more tasks including, but not limited to receiving data from one or more sensors (e.g., sensors 202, magnetometer 270, barometer 268, and/or one or more external sensors), managing the received data (e.g., calibrating), performing one or more processing procedures on the received data, and/or storing the data. In some examples, the sensor module 242 may be configured to detect anomalies in data received from one or more sensors. In some other examples, based on the detected anomalies, the sensor module 242 may transmit a command to one or more systems within the vehicle (e.g., autonomy computing system 200, vehicle interface 204, external interfaces 206, mapping module 232, any combination thereof, or the like) to perform a particular action (e.g., deploying a lighting mitigation tactic).

FIG. 3 illustrates an example block diagram of a sensor module configured to manage a risk mitigation system according to some aspects of the present disclosure. Sensor module 242 may be communicatively coupled to one or more components described in FIG. 2, including, but not limited to, sensors 202, autonomy computing system 200, mapping module 232, vehicle interface 204, controller 240, calibration module 230, any combination thereof, or the like. Sensor module 242 may be configured to facilitate a monitoring session for risk mitigation system 300 associated with one or more autonomous vehicles (e.g., the autonomous vehicle 100 described in FIG. 1 and FIG. 2). The risk mitigation system 300 may be implemented within the autonomous vehicle 100 using one or more computing components including, but not limited to, processors, databases, memory, the components described in FIG. 5, any combination thereof, or the like. When a monitoring session is initiated by autonomous vehicle 100, risk mitigation system 300 may use one or more sensors associated with the autonomous vehicle 100 to mitigate risk associated with lighting striking the autonomous vehicle 100. The monitoring session may be initiated by internal or external triggers, including, but not limited to, the start of a trip of autonomous vehicle 100, ignition of the engine of autonomous vehicle 100, a command received from a remote device associated with an operator/administrator/mechanic/maintenance personnel of autonomous vehicle 100, after the convergence of a filter associated with risk mitigation system 300, data of an associated sensor reaching a threshold value (e.g., a minimum humidity level, detecting precipitation, a temperature, any combination thereof, or the like), etc.

The sensor module 242 may receive data from one or more sensors (e.g., first sensor 304 and/or second sensor 306). Using this data, sensor module 242 may detect and/or verify one or more anomalies associated with the current location and time period of the autonomous vehicle. If risk mitigation system 300 determines that the autonomous vehicle is in a “high-risk area,” then risk mitigation system 300 may transmit a signal for the autonomous vehicle to pull over/park and deploy a risk mitigation tactic (e.g., lightning rod, conductive chain, reduce speed, park in a particular location, any combination thereof, or the like. In some examples, data gathered by sensor module 242 may be stored in database 316 for future use, such as in studies, training data (e.g., for AI/ML models or other neural networks), filter convergence, any combination thereof, or the like.

The first sensor 304 (e.g., magnetometer 270) and/or the second sensor 306 (e.g., barometer 268) may be attached to the autonomous vehicle. In some examples, the first sensor 304 and/or the second sensor 306 may be mounted on the outside of the vehicle (e.g., on the hood, on the roof, on the door, any combination thereof, or the like) in order to monitor the outside environment of the autonomous vehicle. The first sensor 304 and/or the second sensor 306 may monitor the temperature, air pressure, humidity, magnetic fields, wind speeds, precipitation levels, geographic location (e.g., latitude and/or longitude), any combination thereof, or the like. For example, the first sensor 304 may be a magnetometer that may measure the strength, direction, or variations of magnetic fields in the geographic location of the autonomous vehicle. First sensor 304 may be a scalar magnetometer and/or a vector magnetometer, and may measure the magnetic field using one or more methods, including, but not limited to, proton precession, fluxgate, and/or optical pumping. In some examples, second sensor 306 may be a barometer (e.g., a digital barometer) used to measure atmospheric pressure in the geographic location of the autonomous vehicle. In some other examples, additional sensors may be used to supplement and/or use in lieu of data from first sensor 304 and/or second sensor 306. The additional sensors may be global positioning system (GPS) locators, thermometers, hygrometers, anemometers, LiDAR sensors, ceilometer sensors, cameras, lightning sensors, any combination thereof, or the like.

In some examples, sensor module 242 may receive a request to initiate a monitoring session (e.g., at the ignition of the autonomous vehicle's engine, at the request of a remote device associated with the autonomous vehicle, etc.). The monitoring session may require the setup of one or more sensors, including, but not limited to, first sensor 304 and/or second sensor 306. Upon set up, the first sensor 304 may begin receiving orientation data from the outside environment of the vehicle. In some examples, the first sensor 304 may transmit the orientation data to sensor module to generate a filter associated with the first sensor 304 and/or the autonomous vehicle. The filter may be used to process raw sensor data to generate accurate and stable magnetic field readings. In some examples, the filter may be generated by an administrator of the autonomous vehicle and/or sensor module 242 (e.g., a programmer, a driver, an administrator, maintenance personnel, any combination thereof, or the like). In some examples, the filter may be used in conjunction with second sensor 306 to create accurate predictions of when the autonomous vehicle is in a high-risk area. In some examples, the filter may be applied to attitude (e.g., referring to the direction of Earth's magnetic field) reported by the first sensor 304. Using the filter, the first sensor 304 may measure the steady-state perturbations caused by the autonomous vehicle (e.g., the engine and other metallic components), along with the covariance of the attitude. By measuring this data (e.g., the perturbations from the autonomous vehicle and the covariance of the attitude), the first sensor 304 may not need to be calibrated upon set up and thus, may not need to be recalibrated each time the first sensor 304 loses power (e.g., the autonomous vehicle turns off). When sufficient orientation data has been received by the first sensor 304, the filter may converge (e.g., stabilize and consistently reflect the true state of the outside environment in relation to Earth's magnetic field). In some examples, more than one sensor may be set up for the requested monitoring session. Depending on the type of sensor associated with the monitoring session and/or sensor module 242, more than one type of filter may be generated.

In some examples, the convergence of the filter may initiate the monitoring session. In some other examples, an administrator of the autonomous vehicle may receive a notification at a user interface of a user device associated with the autonomous vehicle that risk mitigation system 300 is ready to be used. Over the duration of the monitoring session, the first sensor 304 may transmit sensor data periodically to sensor module 242, and more specifically, to a data manager 308. The sensor data may be transmitted periodically according to a pre-determined frequency associated with first sensor 304. In some examples, the second sensor 306 may also periodically (e.g., periodically according to a pre-determined frequency) transmit sensor data to data manager 308. The duration of the monitoring session may be limited using one or more factors, including, but not limited to, a time limit (e.g., monitoring session is to last 6 hours), a geographic location threshold (e.g., the monitoring session is to be active when there is a lightning strike within 20 miles of the autonomous vehicle, the monitoring session is to be active when in the state of Minnesota, etc.), during particular weather events (e.g., monitoring session should be active when it is raining), any combination thereof, or the like.

Data manager 308, during the monitoring session, may receive and process the raw sensor data. This may include calibrating the data, compressing the data, transforming the data (e.g., changing the format of the data), and in some examples, using the filter to process the data. For example, data manager 308 may add a timestamp to the received data. In some examples, data manager 308 may transmit the data to database 316. Database 316 may store the data in association with the autonomous vehicle 100 and/or additional contextual information, including, but not limited to, date, time, timestamp, associated data from other sensors, any combination thereof, or the like. Data manager 308 may forward the processed raw sensor data to anomaly detection module 310 for additional processing. In some examples, data associated with first sensor 304 may be transmitted to anomaly detection module 310. Data associated with second sensor 306 may be transmitted to database 316 for future reference by anomaly detection module 310.

Anomaly detection module 310 may be configured to predict the likelihood of the occurrence of a lightning strike. If a lightning strike is predicted to occur in a current geographic area associated with the autonomous vehicle, then anomaly detection module 310 may identify the current geographic area as a “high risk” area. Anomaly detection module 310 may receive the processed raw sensor data (e.g., the processed raw sensor data associated with first sensor 304) from data manager 308 and may detect one or more anomalies in the data in real-time. For example, anomaly detection module 310 may determine if an element of the data demonstrates an unusually high measurement when compared to the preceding data (e.g., an anomaly). In some examples, the determination may be based on a temporal profile stored in a location accessible by risk mitigation system 300. For example, the temporal profile may be stored in database 316 and accessed by anomaly detection module 310. The temporal profile may be generated using prior sensor data or may be imported from external sources.

When an anomaly is detected, it may be associated with a particular timestamp, timeframe, and/or additional metadata. Anomaly detection module 310 may identify the timestamp and query database 316 for data associated with second sensor 306 and the particular timestamp. For example, if anomaly detection module 310 identifies an anomaly at 11:52 pm on August 15, anomaly detection module 310 may query database 316 for data associated with the second sensor gathered at 11:52 pm on August 15. The second sensor data may include atmospheric pressure data associated with the same time as the anomaly. If the atmospheric pressure data associated with the particular timestamp meets and/or exceeds a predetermined threshold (e.g., set by an administrator, industry standards, manufacturing standards, research-developed thresholds, any combination thereof, or the like), then anomaly detection module 310 may identify the current geographic area as a high-risk area for lightning strikes. This identification may occur in real-time or near-real-time, as data is being received from one or more sensors (e.g., first sensor 304 and/or second sensor 306).

Anomaly detection module 310 may transmit a signal to autonomy computing system 200 to deploy one or more mitigation tactics. The mitigation tactics may include modifications in the programming of the autonomous vehicle (e.g., a change in speed, a change in navigation, pulling over to the side of the road, stopping at the closest rest stop, any combination thereof, or the like) or using physical mitigation tactics (e.g., deploying a lightning rod, deploying a conductive chain, initiating a lightning sensor, any combination thereof, or the like).

In some examples, the data stored in database 316 (e.g., data from historical monitoring sessions received from first sensor 304 and/or second sensor 306) may be used to generate more precise algorithms for predicting the occurrence of a lightning strike. In some examples, the historical data may be processed to identify trends, correlations, and/or other metadata that may be generated by processing the historical data. The new algorithms may be used by anomaly detection module 310 to predict when the autonomous vehicle is in a high-risk area. In some examples, the historical data may be used to train one or more machine learning models configured to predict when the autonomous vehicle is in a high-risk area.

FIG. 4 illustrates an example flowchart for a risk mitigation system according to some aspects of the present disclosure. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, the method includes receiving 402 from a first sensor mounted on an autonomous vehicle, first sensor data, wherein the first sensor data is associated with a local magnetic field and is received periodically. For example, sensor module 242 (as described in FIG. 3) may receive 402 sensor data from first sensor 304 (as described in FIG. 3) associated with the local magnetic field and the sensor data may be received periodically. The first sensor data may be received 402 as a result of a request to initiate a monitoring session. In some examples, the request to initiate the monitoring session may be received as a result of the beginning of a trip associated with an autonomous vehicle (e.g., autonomous vehicle 100 as described in FIG. 1), as a result of a command from an administrator associated with the autonomous vehicle, receipt of a weather warning (e.g., weather predictions associated with a current geographic area anticipate thunderstorms), any combination thereof, or the like.

Before a monitoring session can begin, the first sensor may require setup. Upon receipt of the request to initiate the monitoring session, setup procedures may be initiated. In some examples, the first sensor may require one or more filters to accurately identify potential anomalies in the data. The method may further include receiving orientation data from the first sensor, wherein the orientation data is received at the beginning of a trip associated with the autonomous vehicle. The orientation data may be considered “baseline” and/or “normal” data used to setup and/or initiate the first sensor. Additionally, the method may further include generating, based on the orientation data, a filter. The filter may be configured to identify anomalies in the data using thresholds based on historical data, research-based thresholds, commands from an administrator, any combination thereof, or the like. The method may further include monitoring the filter to determine if convergence has occurred. A convergence occurs when the orientation data normalizes and begins to reflect the actual data points present in the current external environment. For example, the data from a magnetometer converges when the data points more accurately reflect the magnetic field, orientation, and/or attitude associated with the autonomous vehicle. The method may further include initiating the monitoring session upon a determination that convergence has occurred. In some examples, the first sensor may be a magnetometer.

According to some examples, the method includes processing 404 the first sensor data to identify an occurrence of an anomaly in the first sensor data, wherein the occurrence is associated with a time period. For example, anomaly detection module 310 (as described in FIG. 3) may process 404 the first sensor data from first sensor 304 (as described in FIG. 3) to identify the occurrence of the anomaly in the first sensor data, wherein the occurrence is associated with the time period. The risk mitigation system may analyze the first sensor data received from the first sensor in real-time. The anomaly may be detected based on a temporal profile. In some examples, the risk mitigation system may compare the first sensor data to a temporal profile (e.g., predicted data) and determine if there are differences between the first sensor data and the temporal profile that exceed a certain threshold. The certain threshold may be determined by an administrator, regulatory standards, any combination thereof, or the like.

According to some examples, the method includes requesting 406 data from a second sensor mounted on the autonomous vehicle after identifying an anomaly. For example, anomaly detection module 310 (as described in FIG. 3) may request 406 data from second sensor 306 (as described in FIG. 3) after identifying the anomaly. To confirm that the anomaly indicates a high risk of a lightning strike, the first sensor data may need to be verified with data from the second sensor. In some examples, the second sensor may be a barometer.

According to some examples, the method includes receiving 408, from the second sensor, second sensor data, wherein the second sensor data is associated with an external environment of the autonomous vehicle. For example, anomaly detection module 310 (as described in FIG. 3) may receive 408 the second sensor data from second sensor 306 (as described in FIG. 3). The second sensor data may be transformed by the risk mitigation system to compare to the first sensor data. In some examples, the second sensor data may be periodically received and stored by a database accessible to the risk mitigation system. The risk mitigation system may query the database for the second sensor data.

According to some examples, the method includes processing 410 the second sensor data associated with the time period. For example, anomaly detection module 310 (as described in FIG. 3) may process 410 the second sensor data associated with the time period. In some examples, the risk mitigation system may query a database (e.g., database 316) for the second sensor data. The second sensor data may be stored in association with a particular time stamp, time range, time period, any combination thereof, or the like. The risk mitigation system may process the second sensor data from the database and identify the data associated with the same time period as the anomaly data (e.g., both are gathered at 2:04:57 pm).

According to some examples, the method includes identifying 412, based on the second sensor data and the anomaly, that the external environment is high-risk. For example, the anomaly detection module 310 (as described in FIG. 3) may identify 412, based on the analyzed second sensor data and the anomaly, that the external environment is high-risk. For example, the risk mitigation system may determine if the second sensor data associated with the time period and the anomaly corroborate a prediction that the autonomous vehicle is in an area with a high risk for lightning strikes (e.g., the anomaly and the second sensor data meet and/or exceed a threshold amount, the anomaly and second sensor data fall within a particular data range, the anomaly and the second sensor data are a combination that is categorized as “high risk,” any combination thereof, or the like).

When an area that the autonomous vehicle is traveling through is identified as high risk, the risk mitigation system may transmit a command to a computing system, such as autonomy computing system 200 shown in FIG. 2, associated with the autonomous vehicle to deploy a mitigation tactic. The command may include information about the high-risk area, including probability, size of the high-risk area, potential damage, prediction of a duration of high-risk behavior in the environment, any combination thereof, or the like. With this information and/or additional metadata associated with the command, the computing system may determine an appropriate mitigation tactic. The determination may be made by instructions associated with the computing system (e.g., instructions from an administrator) and/or a machine-learning model trained to deploy risk mitigation strategies in a high-risk area. In some examples, the mitigation tactic may include a modification to the driving of the autonomous vehicle, such as a reduction in speed, change in course, pulling over to park, finding the nearest rest stop, etc. In some examples, the mitigation tactic may include a physical modification to the autonomous vehicle, including deploying a lightning rod, conductive chain, any combination thereof, or the like.

FIG. 5 is an example block diagram of a computing system according to some aspects of the present disclosure that can implement various techniques, processes, functions, or methods described herein. The components of computing system 500 are shown in electrical communication with each other using a connection 502, such as a bus. The example computing system 500 includes a processing unit (or processor) 503 and a computing device connection 501 that couples various computing device components, including computing device memory 505, such as a read only memory ROM 506 and a random-access memory RAM 507, to processor 503.

Computing system 500 can include a cache 504 of high-speed memory connected directly with, in close proximity to, or integrated as part of processor 503. Computing system 500 can copy data from memory 505 and/or storage device 508 to cache 504 for quick access by processor 503. In this way, cache 504 can provide a performance boost that avoids processor 503 delays while waiting for data. These and other modules can control or be configured to control processor 503 to perform various actions. Other computing device memory 505 may be available for use as well. Memory 505 can include multiple different types of memory with different performance characteristics. Processor 503 can include any general-purpose processor, central processing unit (CPU), or graphics processing unit (GPU) in combination with a hardware or software provision configured to control processor 503 and stored in storage device 508, as well as any special-purpose processor where software instructions are incorporated into the processor design. Processor 503 may be a self-contained system, containing multiple cores or processors, a bus, memory controller, cache, etc. A multi-core processor may be symmetric or asymmetric.

Storage device 508 is a non-volatile memory and can be one or more of a hard disk or other types of computer readable media that can store data that are accessible by a computer, such as a magnetic cassette, flash memory card, solid state memory device, digital versatile disk, cartridge, RAM 507, ROM 506, or hybrids thereof. Memory 505 or storage device 508 can include software, code, firmware, etc., for controlling processor 503. Other hardware or software modules are contemplated. Memory 505 and storage device 508 are connected to computing device connection 501. In one aspect, a hardware module that performs a particular function can include the software component stored in a computer-readable medium in connection with the necessary hardware components, such as processor 503, computing device connection 501, and so forth, to carry out the function. In the example embodiment, processor 503 may be programmed by encoding an operation or function using one or more executable instructions and providing the executable instructions in memory 505 or storage device 508.

To enable user interaction, computing system 500 includes an input device 510, which can represent any number of input mechanisms, such as a microphone for speech, a touch-sensitive screen for gesture or graphical input, keyboard, mouse, motion input, speech, etc. Computing system 500 can also include output device 511, which can be one or more of a number of output mechanisms known to those of skill in the art. In some instances, multimodal systems can enable a user to provide multiple types of input/output to communicate with computing system 500. Computing system 500 can include communication interface 509, which can generally govern and manage the user input and system output. There is no restriction on operating on any particular hardware arrangement, and therefore the basic features here may easily be substituted for improved hardware or firmware arrangements as they are developed.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) accurately predicting that a current area associated with an autonomous vehicle is at a high-risk for lightning strikes, (b) increasing the longevity of an autonomous vehicle and associated electrical components by decreasing the likelihood that the autonomous vehicle will get struck by lightning, (c) increasing driving efficiency by only implementing mitigation strategies if there is a present risk of a lightning strike, (d) protecting carried cargo, or (c) developing more accurate prediction algorithms based on historical data gathered by one or more sensors of a risk mitigation system.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. A computer-implemented method, comprising:
receiving, from a first sensor mounted on an autonomous vehicle, first sensor data, wherein the first sensor data is associated with a local magnetic field and is received periodically;
processing the first sensor data to identify an occurrence of an anomaly in the first sensor data, wherein the occurrence is associated with a time period;
requesting data from a second sensor mounted on the autonomous vehicle after identifying the anomaly;
receiving, from the second sensor, second sensor data, wherein the second sensor data is associated with an external environment of the autonomous vehicle;
processing the second sensor data associated with the time period; and
identifying, based on the second sensor data and the anomaly, that the external environment is high-risk.

2. The method of claim 1, further comprising:
receiving orientation data from the first sensor, wherein the orientation data is received at a beginning of a trip associated with the autonomous vehicle;
generating, based on the orientation data, a filter;
monitoring the filter to determine if convergence has occurred; and
initiating a monitoring session upon a determination that convergence has occurred.

3. The method of claim 1, further comprising:
after identifying the external environment as high-risk, transmitting a command to deploy a mitigation tactic.

4. The method of claim 3, wherein deploying the mitigation tactic includes:
transmitting instructions to a vehicle computing system to reduce a speed associated with the autonomous vehicle.

5. The method of claim 3, wherein deploying the mitigation tactic includes:
transmitting instructions to a vehicle computing system to deploy at least one of a lightning rod or a conductive chain.

6. The method of claim 1, wherein the first sensor is a magnetometer.

7. The method of claim 1, wherein the second sensor is a barometer.

8. The method of claim 1, wherein the anomaly is detected based on a temporal profile.

9. A system comprising:
one or more processors;
one or more sensors mounted on an autonomous vehicle; and
a memory storing instructions that, when executed by the one or more processors, configure the system to:
receive, from a first sensor, first sensor data, wherein the first sensor data is associated with a local magnetic field and is received periodically;
process the first sensor data to identify an occurrence of an anomaly in the first sensor data, wherein the occurrence is associated with a time period;
request data from a second sensor after identifying the anomaly;
receive, from the second sensor, second sensor data, wherein the second sensor data is associated with an external environment of the autonomous vehicle;
process the second sensor data associated with the time period; and
identify, based on the second sensor data and the anomaly, that the external environment is high-risk.

10. The system of claim 9, wherein the instructions further configure the one or more processors to:
receive orientation data from the first sensor, wherein the orientation data is received at a beginning of a trip associated with the vehicle;
generate, based on the orientation data, a filter;
monitor the filter to determine if convergence has occurred; and
initiate a monitoring session upon a determination that convergence has occurred.

11. The system of claim 9, wherein the instructions further configure the one or more processors to:
after identifying the external environment as high-risk, transmit a command to deploy a mitigation tactic.

12. The system of claim 11, wherein deploy the mitigation tactic includes:
transmit instructions to an autonomous vehicle computing system to reduce a speed associated with the autonomous vehicle.

13. The system of claim 11, wherein deploy the mitigation tactic includes:
transmit instructions to an autonomous vehicle computing system to deploy at least one of a lightning rod or a conductive chain.

14. The system of claim 11, wherein the first sensor is a magnetometer.

15. The system of claim 11, wherein the second sensor is a barometer.

16. The system of claim 11, wherein the anomaly is detected based on a temporal profile.

17. A non-transitory computer-readable storage medium, the computer-readable storage medium including instructions that when executed by a computer, cause the computer to:
receive, from a first sensor mounted on an autonomous vehicle, first sensor data, wherein the first sensor data is associated with a local magnetic field and is received periodically;
process the first sensor data to identify an occurrence of an anomaly in the first sensor data, wherein the occurrence is associated with a time period;
request data from a second sensor mounted on the autonomous vehicle after identifying an anomaly;
receive, from the second sensor, second sensor data, wherein the second sensor data is associated with an external environment of the autonomous vehicle;
process the second sensor data associated with the time period; and
identify, based on the second sensor data and the anomaly, that the external environment is high-risk.

18. The non-transitory computer-readable storage medium of claim 17, wherein the instructions further cause the computer to:
receive orientation data from the first sensor, wherein the orientation data is received at a beginning of a trip associated with the autonomous vehicle;
generate, based on the orientation data, a filter;
monitor the filter to determine if convergence has occurred; and
initiate a monitoring session upon a determination that convergence has occurred.

19. The non-transitory computer-readable storage medium of claim 17, wherein the instructions further cause the computer to:
after identifying the external environment as high-risk, transmit a command to deploy a mitigation tactic.

20. The non-transitory computer-readable storage medium of claim 17, wherein the anomaly is detected based on a temporal profile.
